(19) United States
(12) Patent Application Publication
(10) Pub. No.: US 2009/0052352 A1
(43) Pub. Date: Feb. 26, 2009

(54) METHOD FOR PROVIDING A SOUND OR THE LIKE, APPARATUS FOR TRANSMITTING A SOUND OR THE LIKE, AND APPARATUS FOR RECEIVING A SOUND OR THE LIKE

(75) Inventor: Shinji TOGAWA, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/166,631

(22) Filed: Jul. 2, 2008

(30) Foreign Application Priority Data
Aug. 20, 2007 (JP) 2007-214179

(51) Int. Cl. H04L 12/16

(52) U.S. Cl. 370/260

(57) ABSTRACT

A method for providing a sound or a moving image from a first apparatus to a second apparatus including allocating sample values belonging to the same first time slot among sample values obtained at individual time points by sampling an analog signal of a sound or a moving image to plural packets in the first apparatus and transmitting the sample-value-allocated packets to the second apparatus from the first apparatus.

### CROSS-REFERENCE TO RELATED APPLICATIONS

This application is based on and claims the benefit of priority to Japanese Application No. 2007-214179, filed on Aug. 20, 2007, the contents of which are incorporated herein by reference.

### BACKGROUND

1. Field

The invention relates to a method for providing a sound or a moving image by packet communication.

2. Description of the Related Art

FIG. 17 illustrates an example of conventional packet communication of a sound.

A procedure as shown in FIG. 17 is followed when sound data or moving image data is exchanged between two apparatus by packet communication. First, a transmission-side apparatus digitizes an analog audio signal Sa′. Then, the transmission-side apparatus forms packets PT (PTa, PTb, . . . ) each containing sample values in a fixed period (usually 20 ms). Then, the transmission-side apparatus transmits the packets PT to a reception-side apparatus. When receiving the packets PT, the reception-side apparatus stores packets PT in a buffer. The reception-side apparatus reproduces a sound by converting the audio data (i.e., the sample values contained in the packets PT) into an analog signal in time order.

If part of the packets PT is lost, the reception-side apparatus cannot reproduce a sound in time slots corresponding to the lost packets. That is, if the packet PTb, for example, is lost, jumping occurs there. It is a known problem that a sound with jumping is harder to recognize than a sound without jumping.

One countermeasure is to use a method disclosed in Japanese Laid-Open Patent Publication No. 2006-319463. In this method, a transmission-side apparatus duplicates an audio packet and transmits double audio packets to a reception-side apparatus. Even if one audio packet is lost, the reception-side apparatus can reproduce a sound using the other audio packet. This makes it possible to reduce the probability of the occurrence of jumping.

Japanese Laid-Open Patent Publication No. H02-143636 discloses the following method. A transmission-side apparatus converts an input audio signal into coded audio signals of plural bits at a prescribed sampling cycle. A first packet is formed from higher plural bits of plural coded audio signals obtained in each frame period and a second packet is formed from lower plural bits. Each of the first packet and the second packet is transmitted in such a manner that one of at least two priority ranks is given to it according to the property of the part of the audio signal that is input in the frame concerned.

### SUMMARY

According to one aspect of the invention, a method includes allocating operation sample values belonging to the same time slot among sample values obtained at individual time points by sampling an analog signal of a sound or a moving image to plural packets in a first apparatus; and transmitting the sample-value-allocated packets to a second apparatus from the first apparatus.

Additional objects and advantages of the embodiment will be set forth in part in the description which follows, and in part will be obvious from the description, or may be learned by practice of the invention.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 shows an example of a configuration of a call system according to an embodiment of the invention;

FIG. 2 shows an example of a hardware configuration of a terminal apparatus;

FIG. 3 shows an example of a functional configuration of a terminal apparatus;

FIG. 4 illustrates an example of a method for allocating sample values to packets;

FIG. 5 is a flowchart showing an example of a process for reconstructing an audio signal;

FIG. 6 illustrates an example of a method for combining the sample values of two packets;

FIG. 7 illustrates an example of a method for reconstructing an audio signal when one packet is lost;

FIG. 8 illustrates a modified method for reconstructing an audio signal when one packet is lost;

FIG. 9 is a flowchart showing an example of a process executed by transmission-side and reception-side terminal apparatus;

FIG. 10 illustrates a modified method for allocating sample values to packets;

FIG. 11 shows an example of audio signals in a case in which a pair of packets is lost;

FIG. 12 illustrates another modified method for allocating sample values to packets;

FIG. 13 shows an example of audio signals in a case in which two successive packets are lost;

FIG. 14 illustrates a further modified method for allocating sample values to packets;

FIGS. 15A-15C show an example of a conventional buffer overflow;

FIGS. 16A-16C show an example of a buffer overflow occurring in the embodiment; and

FIG. 17 illustrates an example of conventional packet communication of a sound.

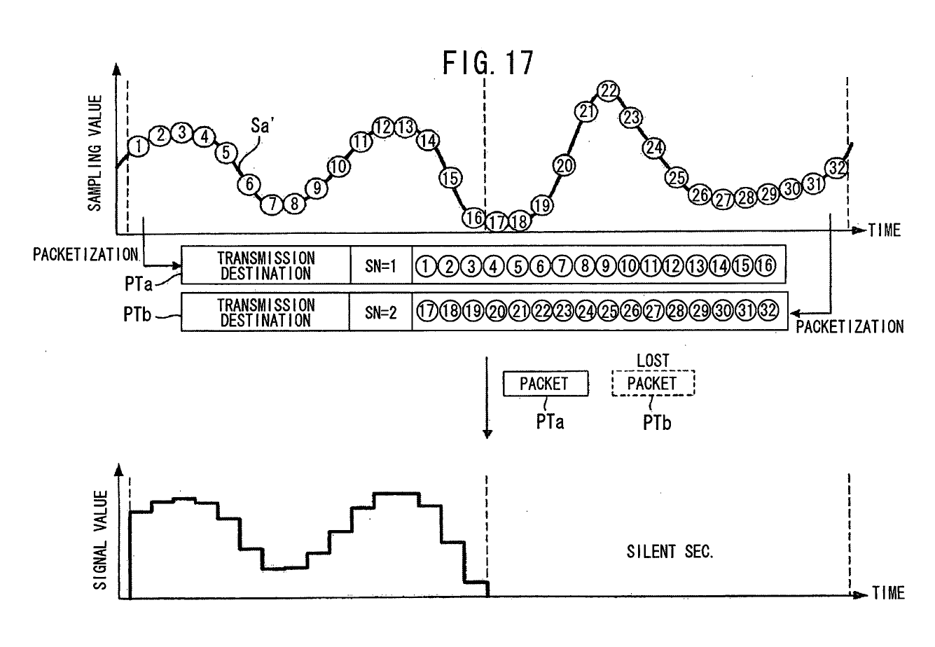

### DETAILED DESCRIPTION OF THE PREFERRED EMBODIMENTS

In the method disclosed in the publication No. 2006-319463, the traffic is increased by the doubling. Therefore, jumping is prone to occur if the capabilities (CPU processing speed, buffer capacity, and NIC communication rate) of a transmission-side or reception-side apparatus are insufficient or the bandwidth of a communication line is insufficient.

The method disclosed in the publication No. H02-143636 has a problem that jumping occurs if processing is not performed according to the priority ranks on a communication line and a first packet (i.e., a packet consisting of higher bits) is thereby lost.

An embodiment described below is intended to solve the above problems.

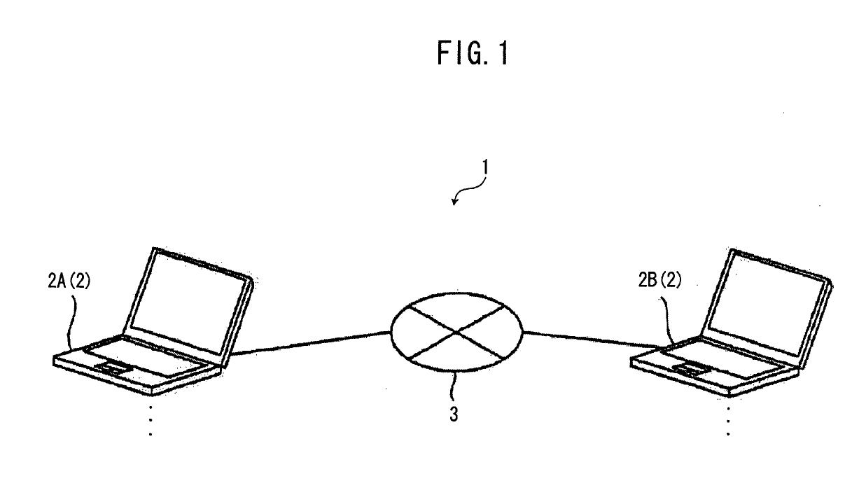

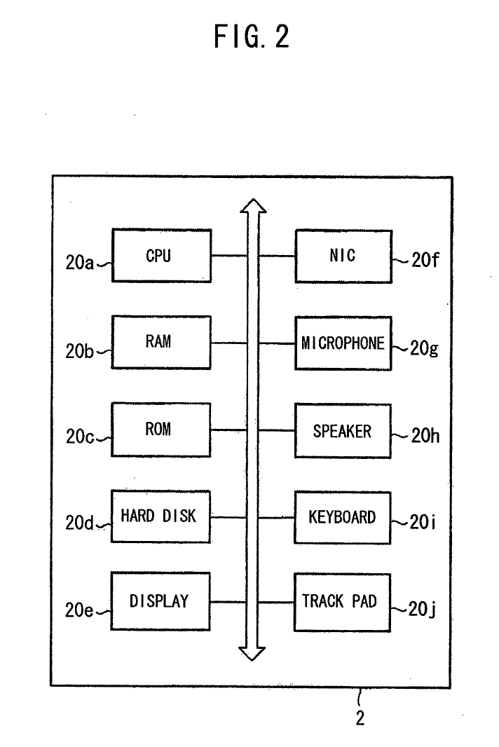

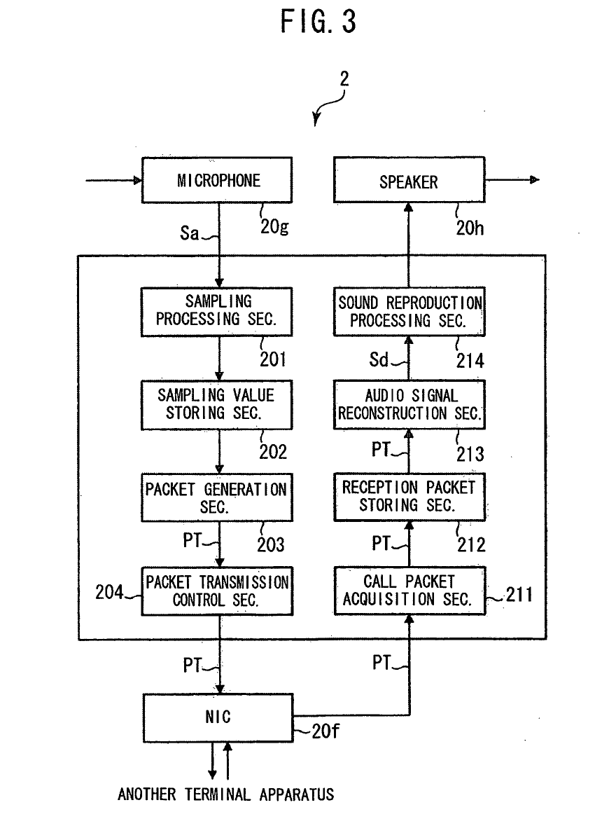

FIG. 1 shows an example of a configuration of a call system 1 according to the embodiment. FIG. 2 shows an example of a hardware configuration of each terminal apparatus 2. FIG. 3 shows an example of a functional configuration of each terminal apparatus 2.

The call system 1 is a system which allows users distant from each other to converse with each other. As shown in FIG. 1, the call system 1 is composed of plural terminal apparatus 2 (2A, 2B, . . . ) and communication lines 3. Examples of the communication lines 3 are the Internet, a LAN, public lines, and dedicated lines.

As shown in FIG. 2, each terminal apparatus 2 is composed of a CPU 20a, a RAM 20b, a ROM 20c, a hard disk 20d, a display 20e, a network interface card (NIC) 20f, a microphone 20g, a speaker 20h, a keyboard 20i, a track pad 20j, etc.

Referring now to FIG. 3, programs and data for realizing the functions of a sample processing section 201, a sample value storing section 202, a packet generation section 203, a packet transmission control section 204, a call packet acquisition section 211, a reception packet storing section 212, an audio signal reconstruction section 213, and a sound reproduction processing section 214 are stored in the ROM 20c or the hard disk 20d. When necessary, these programs and data are loaded into the RAM 20b and the programs are run by the CPU 20a. All or part of the above functions may be implemented by circuits only.

Each terminal apparatus 2 is a personal computer, a PDA (personal digital assistant), or the like. The communication protocol is TCP/IP or the like.

Next, the details of processing performed by each section of each terminal apparatus 2 shown in FIG. 3 and related features will be described.

Process for Delivering a Voice of a Speaking Person to a Listener

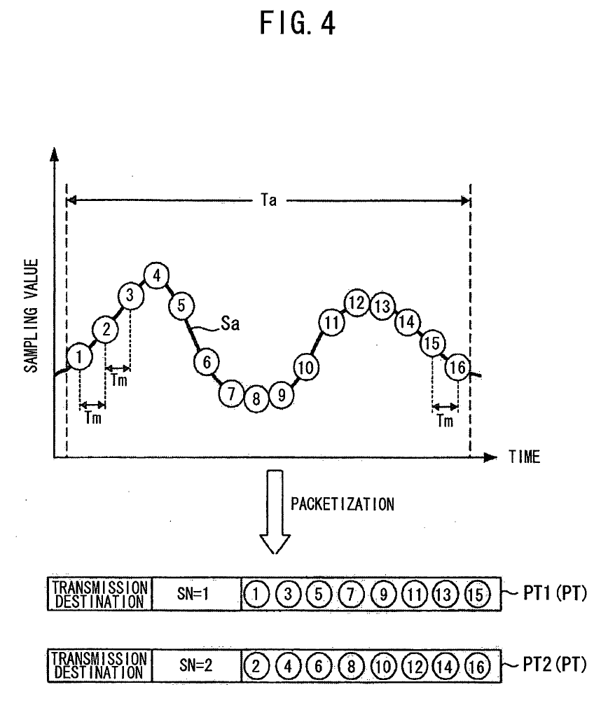

FIG. 4 illustrates an example method for allocating sample values to packets PT.

As shown in FIG. 4, the sample processing section 201 samples and encodes an analog audio signal Sa that is generated by the microphone 20g at a prescribed cycle Tm. A respective value of vertical axis indicated by circled numerals 1, 2, . . . are sample values in the figure.

The sample values produced by the sample processing section 201 are stored temporarily in the sample value storing section 202.

The packet generation section 203 generates packets in the following manner using sample values of a voice in a prescribed period Ta (e.g., 20 ms). To simplify the description, examples shown in the drawings of this specification employ sampling rates that are much lower than in actual cases.

The packet generation section 203 extracts odd-numbered sample values in time order from the sample values in the period Ta stored in the sample value storing section 202. The packet generation section 203 generates a packet PT that contains the extracted sample values, identification information (an IP address, a MAC address, or the like) of a transmission destination apparatus, a sequence number (SN), etc. A packet PT1 shown in FIG. 4 is an example of such a packet.

Furthermore, the packet generation section 203 extracts the remaining sample values (i.e., even-numbered sample values) in the period Ta stored in the sample value storing section 202 in their old order. As in the case of the odd-numbered sample values, the packet generation section 203 generates a packet PT which contains the extracted sample values, the identification information (IP address, MAC address, or the like) of the transmission destination apparatus and a sequence number (SN) etc., such as a packet PT2.

In this manner, the packet generation section 203 generates two packets PT by dividing sample values belonging to the same section into odd-numbered sample values and even-numbered simple values.

Regular sequence numbers are assigned to the two generated packets PT so as to indicate that they are paired as a sequence number. For example, if a sequence number “2n−1” (n: natural number) is assigned to a packet PT consisting of odd-numbered sample values, a sequence number “2n” is assigned to the other packet PT.

The data of the sample values that have been used for the generation of the packets PT are deleted from the sample value storing section 202.

The packet transmission control section 204 controls the network interface card 20f so that the packets PT generated by the packet generation section 203 are transmitted to the call destination apparatus. Then, the packets PT are transmitted to the destination apparatus over the communication lines 3.

Process for Reproducing a Voice of a Speaking Person for a Listener

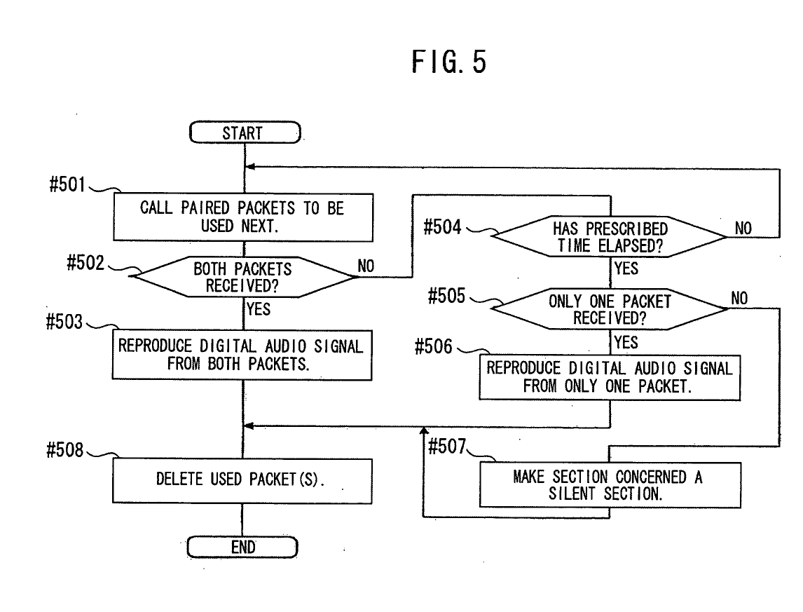

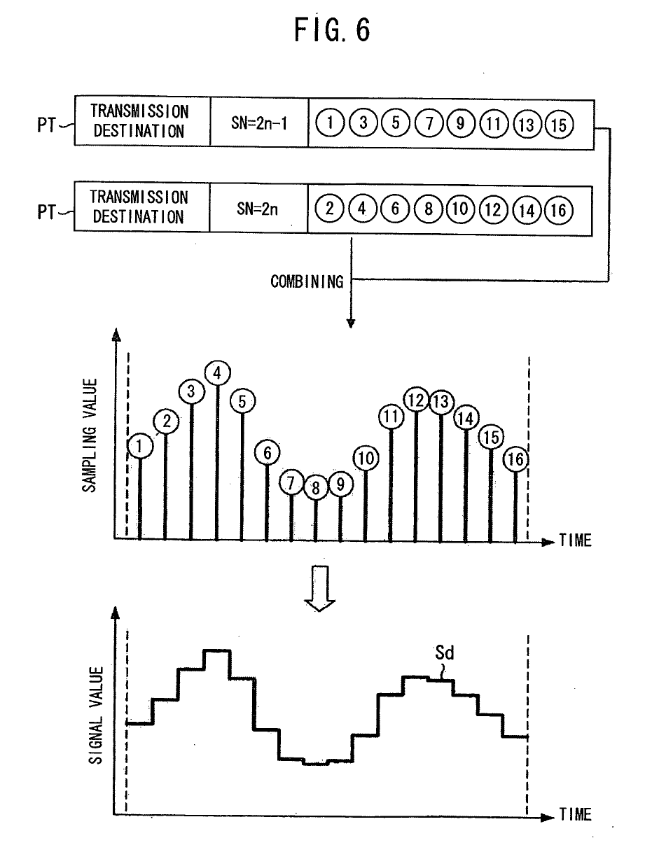

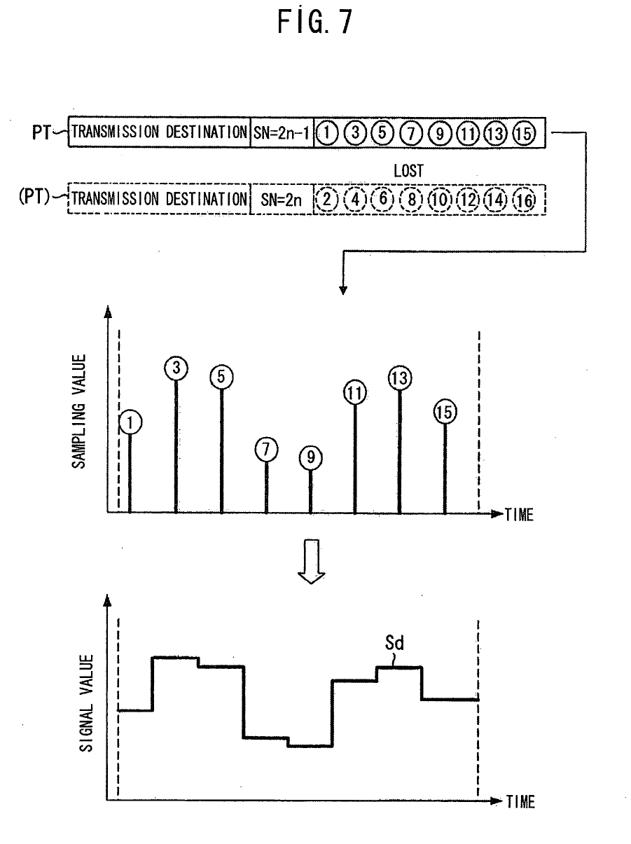

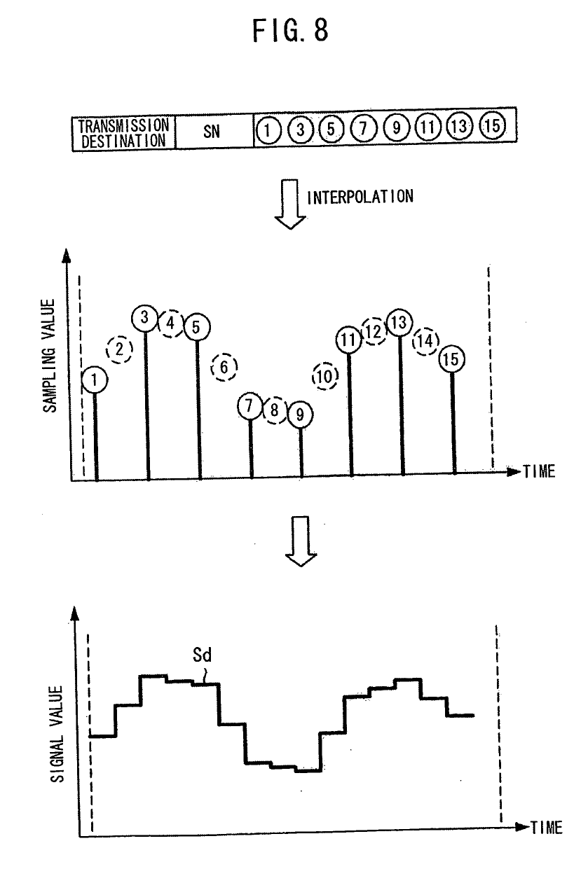

FIG. 5 is a flowchart showing an example process for reconstructing an audio signal Sd. FIG. 6 illustrates an example method for combining the sample values of two packets PT. FIG. 7 illustrates an example method for reconstructing an audio signal Sd when one packet PT is lost. FIG. 8 illustrates a modified method for reconstructing an audio signal Sd when one packet PT is lost.

Referring again to FIG. 3, the call packet acquisition section 211 acquires packets PT transmitted from a speaking-person-side apparatus from various packets received by the network interface card 20f. The acquired packets PT are stored temporarily in the reception packet storing section 212. That is, the reception packet storing section 212 serves as a buffer for received packets.

However, the number of packets that can be stored simultaneously in the reception packet storing section 212 is limited. As described later, packets PT are deleted as soon as they are used by the audio signal reconstruction section 213. Packets PT that have not been used for a prescribed time since their storage are also deleted. Packets Pt that are acquired by the call packet acquisition section 211 with a delay are discarded without being stored in the reception packet storing section 212.

The audio signal reconstruction section 213 reconstructs a digital audio signal Sd by combining packets PT stored in the reception packet storing section 212. A procedure for reconstructing an audio signal Sd will be described with reference to FIGS. 5-7.

As a general rule, the audio signal reconstruction section 213 generates audio signals Sd using packets PT in their old order. In order of transmissions from the transmission source, that is in young order of sequence numbers. Therefore, the sequence number of the packet PT to be used next to reconstruct an audio signal Sd is always managed.

Referring to FIG. 5, at operation #501, the audio signal reconstruction section 213 tries to call a packet to be used next and a packet PT that is paired with it from the reception packet storing section 212.

At operation #502, the audio signal reconstruction section 213 judges whether the paired packets PT have been received before a lapse of a prescribed time Tb (i.e., a time that is short enough to avoid an undue delay of sound; 200 ms, for example) from the order of calling of those packets. If the paired packets PT have been received (#502: yes), at operation S503 the audio signal reconstruction section 213 reproduces an audio signal Sd using the paired packets PT (see FIG. 6). More specifically, the audio signal reconstruction section 213 reproduces an audio signal Sd by using the sample values of the paired packets PT alternately in time order, that is, in order of a first sample value indicated by a circled numeral “1” of the older packet PT, a first sample value indicated by a circled numeral “2” of the newer packet PT, a second sample value indicated by a circled numeral “3” of the older packet PT, a second sample value indicated by a circled numeral “4” of the newer packet PT, . . . .

On the other hand, if only one of the paired packets PT has been received before a lapse of the time Tb (#504: yes, #505: yes), at operation S506 the audio signal reconstruction section 213 reproduces an audio signal Sd using only the received packet PT (see FIG. 7). That is, the audio signal reconstruction section 213 reproduces a digital audio signal Sd as if the sampling cycle were two times that of the case of FIG. 6.

Alternatively, sample values of the packet PT that could not be received (in the example of FIG. 7, sample values corresponding to the even-numbered circled numerals) can be interpolated by using the sample values of the received packet PT (in the example of FIG. 7, the sample values corresponding to the odd-numbered circled numerals). As shown in FIG. 8, each sample value may be interpolated by calculating a simple average of two successive sample values of the received packet PT. As a further alternative, sample values may be interpolated by the least squares method.

If neither of the paired packets PT could be received before a lapse of the time Tb (yes at #504, no at #505), at operation #507 the section corresponding to it is made a silent section.

At operation S508, the audio signal reconstruction section 213 deletes the used packet(s) PT from the reception packet storing section 212. If one or both of the paired packets PT could not be received, even if such a packet is acquired by the call packet acquisition section 211 after a lapse of the time Tb, it is discarded, since it is regarded as invalid.

Returning to FIG. 3, the sound reproduction processing section 214 generates an analog audio signal using the audio signal Sd that has been reconstructed by the audio signal reconstruction section 213. The sound reproduction processing section 214 outputs the analog audio signal to the speaker 20h. In this way, a voice of the speaking person is reproduced from the speaker 20h.

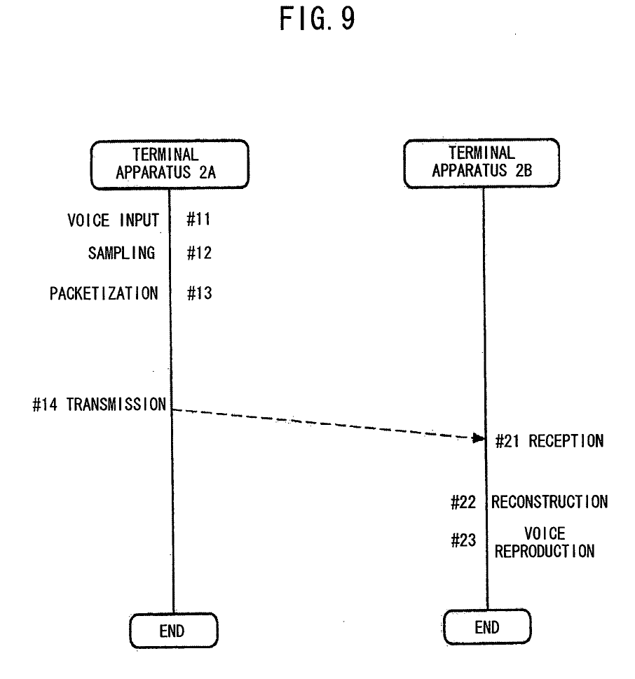

FIG. 9 is a flowchart showing an example of a process executed by transmission-side and reception-side terminal apparatus 2.

A process which is executed by terminal apparatus 2A and 2B when two users UA and UB make a call using the two terminal apparatus 2A and 2B is described with reference to the flowchart of FIG. 9.

After connection between the terminal apparatus 2A and 2B has been established, the user UA of the terminal apparatus 2A speaks in the microphone 20g of the terminal apparatus 2A. The terminal apparatus 2A picks up the voice at operation #11 and performs sample processing at operation #12. The terminal apparatus 2A divides sample values which are generated by the sampling process into groups for each period Ta. At operation #13, as shown in FIG. 4, the terminal apparatus 2A divides the sample values of one group into odd-numbered sample values and even-numbered sample values and converts the sample values into packets PT. At operation #14, the terminal apparatus 2A transmits the thus-generated packets PT to the terminal apparatus 2B. While the user UA continues to speak, operations #11 to #14 are executed as appropriate.

At operation #21, the terminal apparatus 2B receives packets PT one after another from the terminal apparatus 2A. At operation #22, as shown in FIG. 6, the terminal apparatus 2B reconstructs audio signals Sd one after another using pairs of packets PT in their old order. If only one of the paired packets PT is received, the terminal apparatus 2B reconstructs an audio signal Sd using only the received packet PT (see FIG. 7).

At operation #23, the terminal apparatus 2B reproduces an analog audio signal by connecting the reconstructed audio signals Sd arranged in time order, and outputs the analog audio signal from the speaker 20h.

A voice of the user UB is transmitted in such a manner that the processes executed by the terminal apparatus 2A and 2B in this order in the above example are executed by the terminal apparatus 2B and 2A in this order.

This embodiment can make the probability of occurrence of jumping lower than the conventional cases without increasing the traffic.

Although the embodiment is directed to the case of a two-party call, the invention can also be applied to a call involving three or more parties.

Although the embodiment is directed to the case of a two person call, the invention can also be applied to the case of a three or more person call.

Although the embodiment is directed to the call system 1 which is constructed by personal computers and TCP/IP, etc., the invention can also be applied to a call system of a cell phone network, PHS, or the like.

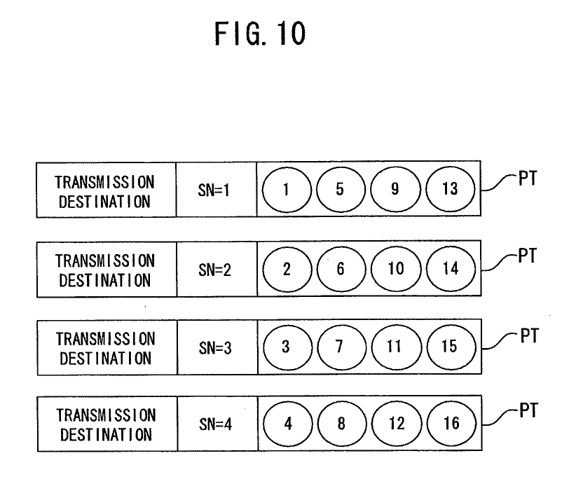

FIG. 10 illustrates a modified method for allocating sample values to packets PT.

In the embodiment, as shown in FIG. 4, sample values in one time slot are allocated to two packets PT. Alternatively, they may be allocated to three or more packets PT. For example, they may be allocated to four packets PT in a manner shown in FIG. 4.

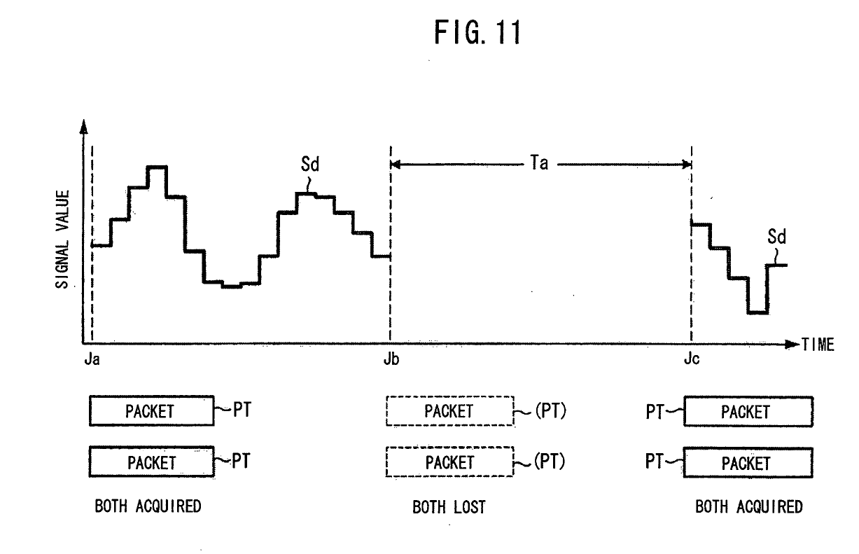

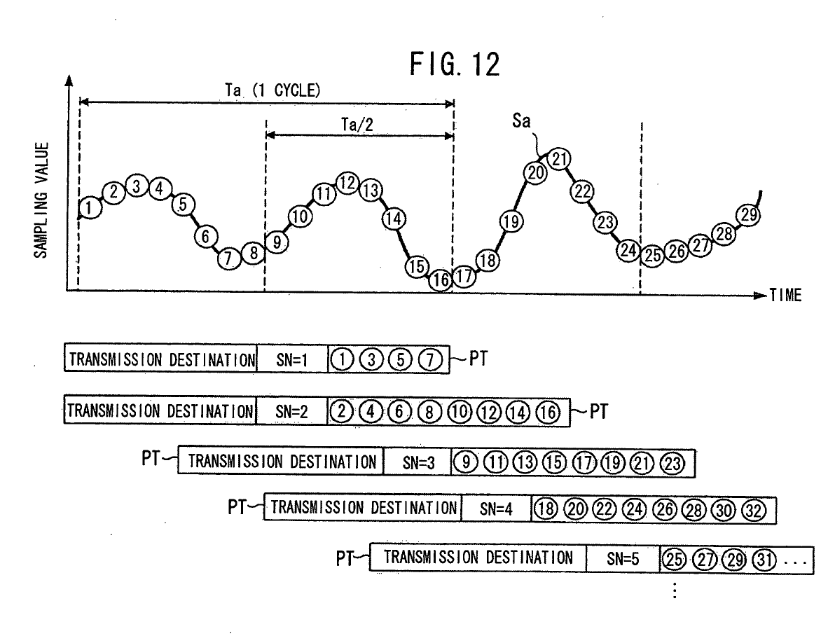

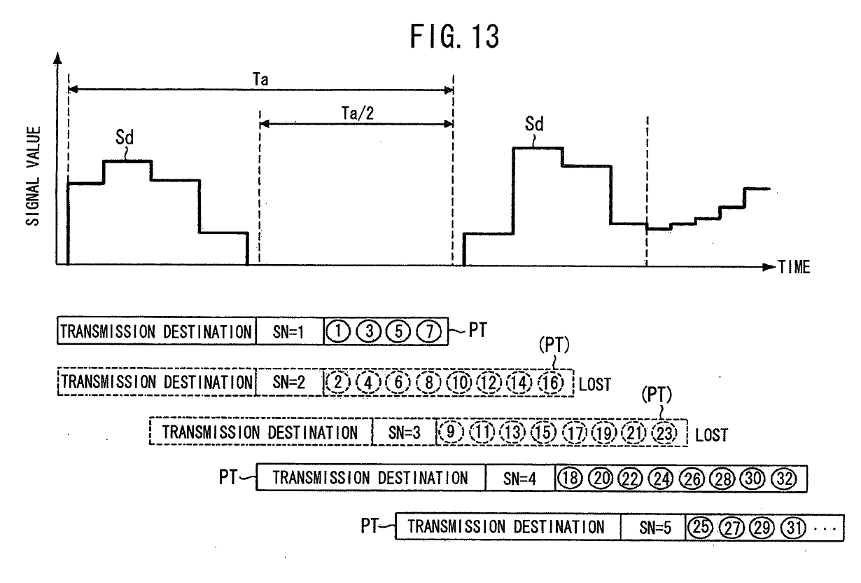

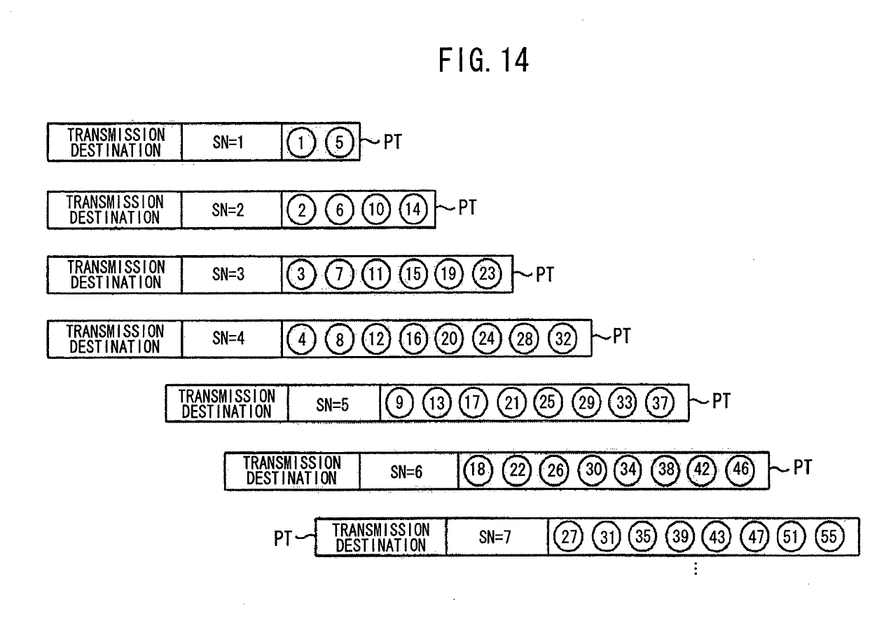

FIG. 11 shows example audio signals Sd of a case that a pair of packets PT are lost. FIG. 12 illustrates another modified method for allocating sample values to packets PT. FIG. 13 shows example audio signals Sd of a case that two successive packets PT are lost. FIG. 14 illustrates a further modified method for allocating sample values to packets PT.

In the method described above with reference to FIGS. 5 and 6, the speaking-person-side terminal apparatus 2 transmits a pair of packets PT simultaneously. Therefore, both packets PT may be lost due to the same event. If both packets PT are lost, a silent section occurs like a section from time Jb to time Jc in FIG. 11 and jumping occurs there. One method for lowering the probability of an occurrence of jumping is to construct each terminal apparatus 2 in the following manner.

The packet generation section 203 of a speaking-person-side terminal apparatus 2 generates packets PT as shown in FIG. 12 according to the following rules (1)-(3):

(1) Generate one packet every time slot having a length Ta/2.

(2) Allocate odd-numbered sample values in a (u−1)th time slot and odd-numbered sample values in a uth time slot to a uth packet PT, where u is a positive odd number. But the first packet PT is allocated odd-numbered sample values in only the first time slot.

(3) Allocate even-numbered sample values in a (v−1)th time slot and even-numbered sample values in a vth time slot to a vth packet PT, where v is a positive even number. The last packet PT is allocated odd-numbered sample values in only the last time slot.

The packet transmission control section 204 transmits generated packets PT one after another to a listener-side terminal apparatus 2.

On the other hand, the audio signal reconstruction section 213 of the listener-side terminal apparatus 2 reconstructs an audio signal Sd by alternately using the sample values of the second half of an nth packet PT and the sample values of the first half of an (n+1)th packet PT.

Since, as described above, a speaking-person-side terminal apparatus 2 generates and transmits one packet every half cycle (length: Ta/2), two successive packets being lost due to the same event may be prevented.

Furthermore, as shown in FIG. 13, the length of a silent section, which occurs if two successive packets PT could not reach a listener-side terminal apparatus 2, can be shortened to about ½ of the length of the silent section shown in FIG. 11.

Alternatively, as shown in FIG. 14, sample values may be allocated to packets PT in such a manner that one packet PT is generated every time slot having a length Ta/4.

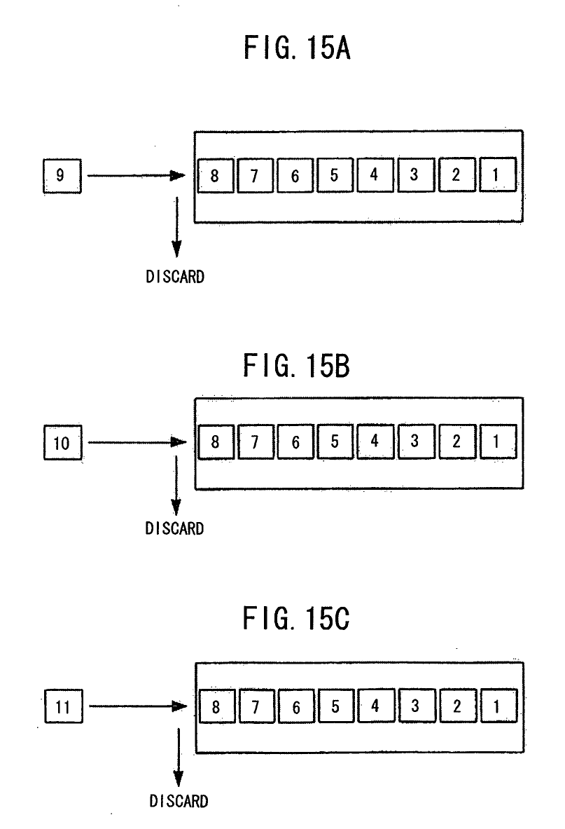

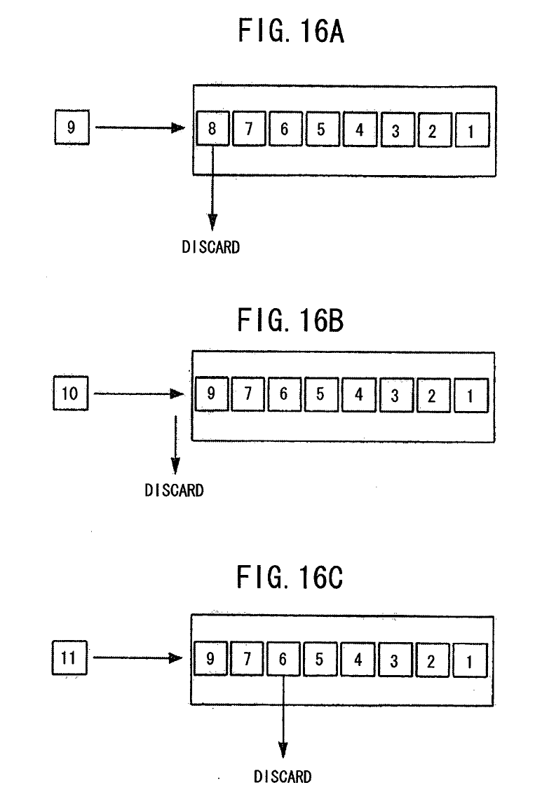

FIGS. 15A-15C show an example of a conventional buffer overflow. FIGS. 16A-16C show an example of a buffer overflow occurring in the embodiment. Numerals shown in FIGS. 15A-15C and 16A-16C are sequence numbers.

Conventionally, if data occurs that should be stored in a buffer that is already full, the data is discarded without being stored in the buffer.

An example will be described in which this conventional method is applied to the reception packet storing section 212. For example, if the rate at which the call packet acquisition section 211 acquires packets PT is higher than the rate at which packets PT stored in the reception packet storing section 212 are processed, plural packets PT having successive sequence numbers are discarded as shown in FIGS. 15A-15C. However, this causes jumping as described above with reference to FIG. 11.

In view of the above, what packets PT should be stored in the buffer with higher priority may be determined in advance. For example, priority is given to packets PT having odd sequence numbers. If a packet PT having an odd sequence number is acquired, as shown in FIGS. 16A and 16C, one packet PT having an even sequence number among the packets PT stored in the reception packet storing section 212 is deleted. The acquired packet PT is then stored in the reception packet storing section 212. When a packet PT having an even sequence number is received, it is discarded as shown in FIG. 16B as in the conventional example.

The method of FIGS. 16A-16C is particularly effective for an IP network that is prone to fluctuations and delays. If the degree of fluctuation increases in an IP network, a buffer overflow becomes prone to occur. However, as described above, jumping can be prevented even if a buffer overflow occurs.

Alternatively, three or more priority ranks may be provided. For example, priority ranks may be provided in such a manner that first priority is given to packets PT whose sequence numbers are multiples of 4 and second priority is given to packets PT whose sequence numbers are multiples of 4 minus 2. As a further alternative, priority ranks may be provided according to another set of arithmetic progressions.

The configurations of the whole and the individual components of the call system 1 and each terminal apparatus 2, the processes executed therein, the order of execution of the processes, the packet structure, etc. can be modified as appropriate without departing from the spirit and scope of the invention.

The turn of the embodiments isn't a showing the superiority and inferiority of the invention.

Although the embodiments of the inventions have been described in detail, it should be understood that the various changes, substitutions, and alterations could be made hereto without departing from the spirit and scope of the invention.

What is claimed is:

1. A method for providing a sound or a moving image from a first apparatus to a second apparatus, the method comprising:
allocating sample values belonging to the same first time slot among sample values obtained at individual time points by sampling an analog signal of a sound or a moving image to plural packets in the first apparatus; and
transmitting the sample-value-allocated packets to the second apparatus from the first apparatus.

2. The method according to claim 1, wherein the sample values are allocated alternately to the plural packets in order of sampling time points so that a prescribed number of sample values are allocated to each of the plural packets.

3. The method according to claim 1, wherein part of sample values belonging to a second time slot which is different from the first time slot are allocated to one of the plural packets and at least part of remaining sample values belonging to the second time slot are allocated to another of the plural packets.

4. The method according to claim 2, wherein part of sample values belonging to a second time slot which is different from the first time slot are allocated to one of the plural packets and remaining sample values belonging to the second time slot are allocated to the other of the plural packets.

5. The method according to claim 1, further comprising reproducing a sound or a moving image on the basis of the sample values contained in packets that are transmitted from the first apparatus to the second apparatus.

6. The method according to claim 2, further comprising reproducing a sound or a moving image on the basis of the sample values contained in packets that are transmitted from the first apparatus in the second apparatus.

7. The method according to claim 3, further comprising, in the second apparatus, reproducing a sound or a moving image on the basis of the sample values contained in packets that are transmitted from the first apparatus.

8. The method according to claim 6, further comprising storing a packet in a buffer with higher priority if its sequence number is equal to one term of a prescribed arithmetic progression among packets that are transmitted from the first apparatus in the second apparatus.

9. A transmission apparatus which transmits a sound or a moving image to a destination apparatus, comprising:
a packet allocating section for allocating sample values belonging to the same time slot among sample values obtained at individual time points by sampling an analog signal of a sound or a moving image to N packets, N being a natural number that is greater than or equal to 2; and
a transmitting section for transmitting the packets to the destination apparatus.

10. A receiving apparatus comprising
a receiving section for receiving packets of a sound or a moving image from a transmission apparatus;
a packet storing section for storing, with higher priority, a packet if its sequence number is equal to one term of a prescribed arithmetic progression among the received packets; and
a reproducing section for reproducing a sound or a moving image on the basis of sample values contained in packets stored in the packet storing section.

11. The receiving apparatus according to claim 10, wherein the receiving section receives the packets from the transmission apparatus according to claim 9.
